(19) United States
(12) Patent Application Publication
(10) Pub. No.: US 2023/0153926 A1
(43) Pub. Date: May 18, 2023

(54) Automated Plant Probe System and Method

(71) Applicant: Raye L. Daugherty, Milwaukee, WI (US)

(72) Inventor: Raye L. Daugherty, Milwaukee, WI (US)

(21) Appl. No.: 18/054,689

(22) Filed: Nov. 11, 2022

Related U.S. Application Data
(60) Provisional application No. 63/279,172, filed on Nov. 14, 2021.

(51) Int. Cl. G06Q 50/02; G06T 7/00; A01C 21/00; A01G 25/16

(52) U.S. Cl. CPC G06Q 50/02; G06T 7/0004; A01C 21/007; A01G 25/16; G06T 2207/30188

(57) ABSTRACT

Embodiments of the invention provide an automated plant probe system and method. The plant probe can include a body and a housing with a hardware module. The hardware module can include a communication module, an electronic controller, and memory. The plant probe can include a probe with a sensor module. The sensor module can including various sensors, such as a moisture sensor and/or a growing media sensor. The plant probe system can include a control system in communication with the communication module of the plant probe. The control system can receive plant data from the sensor module and use the plant data to provide plant recommendations.

### BACKGROUND

Conventional garden and houseplant probes are generally analog devices that measure certain characteristics of the soil (e.g., moisture, pH, light, and fertilizer) when the probe is inserted into the soil or growing media. Conventional automated watering systems often include a controller that opens and closes valves coupled to watering hoses based on a time of day and a watering duration.

Home gardens are becoming more prevalent as a result of flexible work arrangements and a desire for local, sustainable agriculture. It is estimated that the meals in the United States travel about 1,500 miles to get from farm to plate. Gardeners want to grow their own produce in order to control the quality and type of produce and eliminate long-distance produce transportation.

Many gardeners desire locally-grown, organic produce. Organic gardening helps to prevent a loss of topsoil, toxic runoff, water pollution, soil contamination, soil poisoning, death of insects, birds, animals and other beneficial soil organisms, as well as eliminating pesticide, herbicide, and fungicide residues on food from synthetic fertilizers. However, a novice gardener may find it difficult to determine which particular organic materials should be used on particular plants and at particular times during a growing season.

Succession planting is the practice of seeding crops at intervals of seven to 21 days in order to maintain a consistent supply of harvestable produce throughout the season. Succession planting also involves planting a new crop after harvesting the first crop. Gardeners often desire fresh produce all season long, but may not have the time or space for processing and storing a large single harvest. Gardeners want to maximize space in their gardens, extend the growing season for as long as possible, and reduce the risk of crops being ruined by poor weather, pests, or disease. In a particular zone of plant hardiness, it may be possible to plant several crops throughout a growing season, but it is difficult to determine the timing for subsequent seed plantings so that the particular crop germinates at the proper temperature and the produce ripens before the first frost.

Seeds and plants are designated with plant hardiness zones, for example as shown in the map of FIG. 8. Plant hardiness zones dictate whether a plant will survive through a winter and return the following spring as a perennial. A plant located in a warmer hardiness zone may be a perennial, while the same plant located in a colder hardiness zone may be an annual. However, the plant hardiness zones may shift over time due to weather changes and climate change, causing changes in the types of plants that can be maintained as perennials or annuals in particular locations.

As a result of climate change, higher average temperatures and shifting precipitation patterns are causing plants to bloom earlier, creating unpredictable growing seasons. Climate change can disrupt food availability, reduce access to food, and affect food quality. For example, projected increases in temperatures, changes in precipitation patterns, changes in extreme weather events, and reductions in water availability may all result in reduced agricultural productivity. Rising carbon dioxide levels and a warmer earth means plants may grow bigger and require more water. Plants react sensitively to fluctuations in temperature. When temperatures rise, plants grow taller in order to cool themselves off. Their stalks become taller and their leaves become narrower and grow farther apart.

Home gardeners can be an important part of the solution to climate change by using climate-friendly practices in gardens and landscapes. Sustainable gardening and landscaping techniques can slow future warming by reducing carbon emissions and increasing carbon storage in the soil. Home gardens can help reduce negative environmental impacts by promoting sustainable agriculture, reducing food transportation costs, and reducing water runoff.

Houseplants are becoming an important aspect of interior design. Many homeowners unfamiliar with houseplant types and the necessary growing conditions may find it difficult to water and fertilize each plant in the required manner.

### SUMMARY

In light of the above, a need exists for an automated plant probe system that determines local planting conditions and communicates with a mobile device to assist a user with planting or gardening maintenance recommendations.

Some embodiments of the invention provide a plant probe system including one or more plant probes that can communicate with a mobile device. The plant probe can include a body and a housing. In some embodiments, the body includes a display. The housing can include a hardware module. The hardware module can include a communication module, an electronic controller, and memory. The plant probe can also include a probe with a sensor module. The sensor module can include a moisture sensor and/or a growing media sensor. The plant probe system can further include a control system in communication with the communication module. The control system can receive plant data from the sensor module and use the plant data to provide plant recommendations.

In some embodiments of the invention, the control system can include a number of modules to process plant data and provide recommendations. The control system can include a weather module to provide recommendations for planting dates. The control system can include a growing media module to analyze data from the growing media sensor to determine at least one of pH, nitrogen, phosphorous, or potassium and provide recommendations for fertilizer application. The control system can include a planting module to provide recommendations regarding at least one of planting locations, plant species, or companion planting. The control system can include a succession planting module to provide recommendations regarding succession planting for crops being periodically harvested during a growing season. The control system can include a maintenance module to provide recommendations regarding watering, fertilizer, pest control, sunlight, and/or artificial light. The control system can include a harvest module to provide recommendations regarding dates for harvesting plants during a growing season. The control system can include a home automation module that provides control signals for sprinklers, drip hoses, drip lines, valves, pumps, and/or artificial lights. The control system can include a preservation module to provide recommendations regarding drying, freezing, storing, and/or canning harvested plants. The control system can include a recipe module to provide recommendations for recipes using a harvested plant. The control system can include a calendar module to populate a calendar with recommended dates for planting, maintaining, and/or harvesting plants within a growing season. The control system can include a nutrient deficiency module to provide an alert when data from the growing media sensor indicates a nutrient deficiency. The control system can include a compost module to provide recommendations for growing media amendments based on data received from the growing media sensor. The control system can include a plant hardiness zone and location module to determine a location of the plant probe. The control system can include an image recognition system that receives image data from a camera, and the image recognition system can determine plant type, pest presence, and/or weed presence. The control system can also include a crop rotation module, a seed and plant ordering module, and a social media module.

Some embodiments of the invention include a method of providing a maintenance action for a plant based on a location of a plant probe. The method can include positioning a plant probe and determining a location of the plant probe. The method can further include determining, by an electronic controller, a maintenance action to be performed at the location of the plant probe, and transmitting, by the electronic controller, the maintenance action to at least one of a display and an automated maintenance system.

One embodiment of the invention provides a method of providing a planting action. The method can include positioning a plant probe, determining a location of the plant probe, determining a plant type, and determining a plant hardiness zone at the location. The method can further include determining a succession planting date for the plant type at the location in the plant hardiness zone, generating an automatic calendar entry for the succession planting date, and transmitting the automatic calendar entry to a mobile device.

Another embodiment of the invention provides a method of providing a planting action including determining a first plant type, determining a nutrient requirement for the first plant type in a growing media, and recommending a second plant type to replenish the nutrient requirement in the growing media.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a plant probe system according to one embodiment of the invention.

FIG. 2 is a block diagram of a wireless communication device for use with the plant probe system of FIG. 1.

FIG. 3 is a block diagram of plant probe electronics according to one embodiment of the invention for use with the plant probe system of FIG. 1.

FIG. 4 is a flowchart of a method of automatically adjusting one or more settings of a plant maintenance system based on a location of a plant probe.

FIG. 5 is a flowchart of a method of wireless communication from a plant probe to operate a plant maintenance system.

FIG. 6 is a schematic diagram of a plant probe according to one embodiment of the invention.

FIG. 7 is a block diagram of a control system for use with the plant probe system of FIG. 1.

FIG. 8 is a map of plant hardiness zones in the United States.

FIG. 9 is a table of initial planting dates, plant species, actions, and locations generated by an initial planting module.

FIG. 10 is a diagram of a raised bed garden plan generated by the initial planting module.

FIG. 11 is a diagram of crop rotation for use by a crop rotation module.

FIG. 12 is a diagram of the raised bed garden plan of FIG. 10 with the crops rotated as recommended by the crop rotation module.

### DETAILED DESCRIPTION

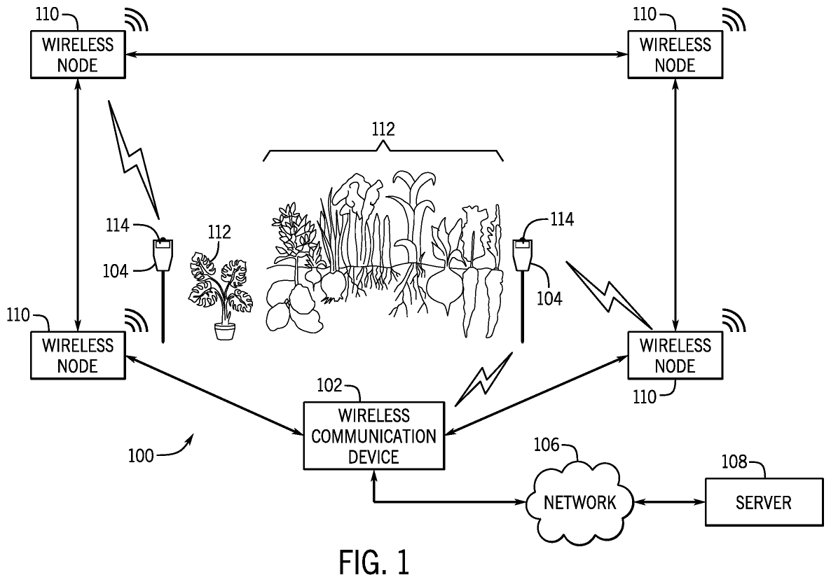

FIG. 1 illustrates a plant probe system 100, which may implement plant recognition, plant care recommendations, and maintenance actions. The plant probe system 100 can include a wireless communication device 102, one or more plant probes 104, a network 106, a server 108, and one or more wireless nodes 110. One or more plant probes 104 can be installed in a garden area (e.g., at each end of a garden and/or a mid-point of the garden), one plant probe 104 in each raised bed, one plant probe 104 in each pot or room, or a single plant probe 104 can represent the growing conditions in an entire garden area or enclosed space, such as a residential home or room, a business location, or a greenhouse. If more than one plant probe 104 is included in the system 100, the data from each plant probe 104 can be used individually, the data can be aggregated, the data can be averaged, etc.

In some embodiments, the plant probe system 100 is capable of determining the position of one or more plants 112 and the plant probe 104 within a frame of reference, which may be a frame of reference defined, for example, by the wireless communication device 102 and/or wireless nodes 110, and a fixed reference location for a garden, home, residential address, or a global position system (GPS) location. The plant probe system 100 is capable of determining plant data indicative of the plant 112. For example, the plant data may include the type of plant, the size or other dimensions of the plant, the plant location, the plant condition, the presence of weeds or pests, etc.

In some embodiments, the plant position and plant data can be determined based on images of the plant 112, which may be recorded by one or more cameras 114 of the plant probe 104. In some instances, the locations of the one or more cameras 114 may be fixed and may define, in whole or in part, the frame of reference within which the plant 112 and its position are defined.

The wireless communication device 102 can be configured to directly (and indirectly) communicate with the plant probe 104. For example, the plant probe 104 can directly communicate with the wireless communication device 102 (e.g., the wireless communication device 102 and the plant probe 104 can directly transmit and receive wireless signals). In other instances, the plant probe 104 can indirectly communicate with the wireless communication device 102 via one or more wireless nodes 110.

In some embodiments, the wireless communication device 102 can be implemented in different ways. For example, the wireless communication device 102 can include components such as a processor, memory, a display, inputs (e.g., a keyboard, a mouse, a graphical user interface, a touch-screen display, one or more actuatable buttons, etc.), or communication devices (e.g., an antenna and appropriate corresponding circuitry), etc. In some embodiments, the wireless communication device 102 can simply be implemented as a processor. In some specific embodiments, the wireless communication device 102 can be implemented as a mobile phone (e.g., a smart phone), a personal digital assistant (“PDA”), a laptop, a notebook, a netbook computer, a tablet computing device, etc.

In some embodiments, the wireless communication device 102 can include a power source (e.g., an AC power source, a DC power source, etc.), which can be in electrical communication with one or more power outlets (e.g., AC or DC outlets) and/or one or more charging ports (e.g., for charging a battery of a plant probe). In some embodiments, the wireless communication device 102 can be implemented in other ways. For example, the wireless communication device 102 can be a cellular tower, a Wi-Fi router, etc. In some embodiments, the wireless commination device 102 also serves as a wireless node (e.g., it performs the functions of both the wireless communication device 102 and a wireless node 110). The wireless communication device 102 can receive or determine position data for the plant probe 104 and can transmit plant probe data.

The plant probe 104 can be configured to communicate directly, or indirectly, with the wireless communication device 102 and/or wireless nodes 110. In some configurations, the plant probe 104 can directly communicate with the wireless communication device 102 according to a wireless communication protocol, which can be a Bluetooth® wireless protocol, a Wi-Fi® wireless protocol, etc.

In some embodiments, the plant probe 104 can include one or more antennas (e.g., as part of one or more Bluetooth® wireless modules) that are capable of communicating with other devices (e.g., other plant probes and/or wireless communication devices) according to a Bluetooth® wireless protocol, which can have advantages as compared to other wireless protocols (e.g., using less power to communicate, providing fast communication speeds, ensuring one-to-one pairing between devices at some times, etc.). For example, a mesh network of plant probes 104, wireless communication devices 102, and/or wireless nodes 110 can be a Bluetooth mesh network.

In some embodiments, the plant probe 104 can include an identifier that uniquely identifies the respective plant probe 104. For example, the plant probe identifier can be a media access control (“MAC”) address, other unique identification information, etc.

In some cases, the plant probe system 100 can include a network 106 and a server 108. The wireless communication device 102 can communicate with the server 108 via the network 106. More particularly, the wireless communication device 102 can communicate with an access point of the network 106 to communicate with the server 108 over the network 106. An access point can include, for example, a cellular tower or a Wi-Fi router. Additionally, the wireless communication device 102 can serve as a gateway device to enable a plant probe 104 to communicate with the server 108 (via the network 106).

In some instances, the one or more wireless nodes 110 may be similar in construction to the wireless communication device 102. Alternatively, each wireless node 110 may be a different device that enables wireless communication between two or more devices. In some cases, each of these wireless nodes 110 can include a power source, an antenna, a receiver, an electronic controller, etc., and each of these can be configured to communicate according to a Bluetooth® wireless protocol, a Wi-Fi protocol, or the like. In some configurations, the mesh network can be a Bluetooth® mesh network.

The particular number, types, and locations of components with the plant probe system 100 of FIG. 1 are merely used as an example for discussion purposes, and thus additional or different types of plant probes 104, networks 106, servers 108, wireless nodes 110, plants 112, and/or cameras 114, can be present in other embodiments of the plant probe system 100.

In some embodiments, the wireless communication device 102 and/or server 108 can store various types of data to be retrieved by the plant probe system 100. These data can be stored in a database, a memory, or other data storage medium or device of the wireless communication device 102 and/or server 108.

The wireless communication device 102 and/or server 108 can store data for various plant probes including usage data for the plant probes (e.g., number of hours of available operation for a plant probe), operator information for the plant probes, location data for the plant, among other data. In some cases, the plant probe 104 of the plant probe system 100 can periodically or occasionally attempt to communicate one or more types of plant data back to the wireless communication device 102 and/or server 108, or to otherwise communicate with the wireless communication device 102, server 108, or wireless nodes 110 of the plant probe system 100.

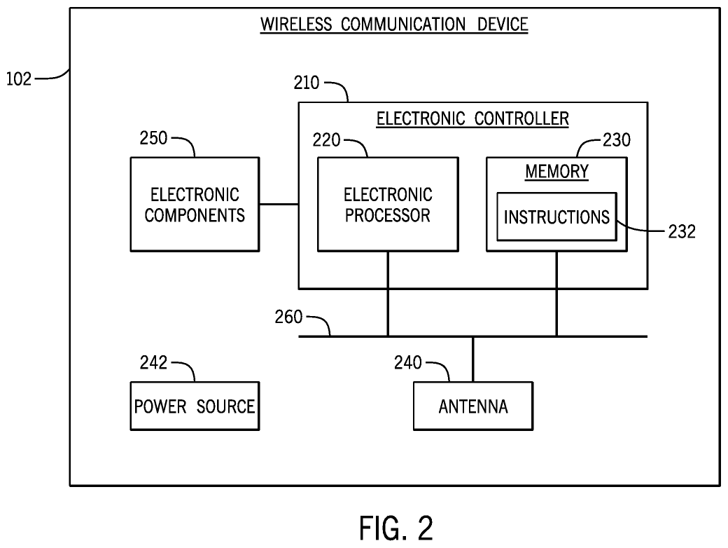

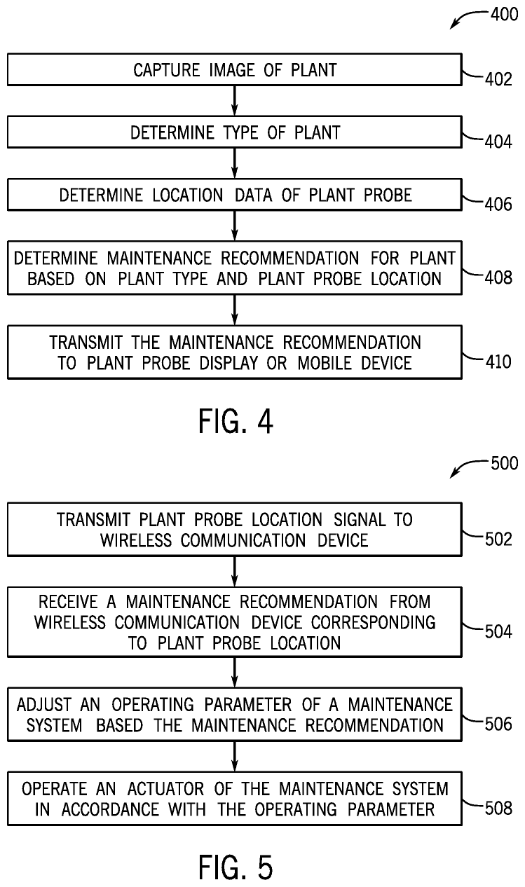

FIG. 2 illustrates a wireless communication device 102 that includes an electronic controller 210, an antenna 240, a power source 242, and electronic components 250. The electronic controller 210 can include an electronic processor 220 and a memory 230. The electronic processor 220, the memory 230, and the antenna 240 can communicate over one or more control buses, data buses, etc., which can include a device communication bus 260. The electronic processor 220 can be configured to communicate with the memory 230 to store data and retrieve stored data. The electronic processor 220 can be configured to receive instructions and data from the memory 230 and execute the instructions. The electronic processor 220 executes instructions stored in the memory 230. Thus, the electronic controller 210 coupled with the electronic processor 220 and the memory 230 can be configured to perform the methods described herein (e.g., the processes 400 and 500 of FIGS. 4 and 5).

The memory 230 can include read-only memory (“ROM”), random access memory (“RAM”), other non-transitory computer-readable media, or a combination thereof. The memory 230 can include instructions 232 for the electronic processor 220 to execute. The instructions 232 can include software executable by the electronic processor 220 to enable the electronic controller 210 to, among other things, determine or receive data of the plant 112; determine or receive position data of the plant 112; determine, select, and/or receive location data for the plant 112; determine or receive position data of the plant probe 104; and determine, select, and/or transmit settings data to the plant probe 104.

The antenna 240 can be communicatively coupled to the electronic controller 210. The antenna 240 enables the electronic controller 210 (and, thus, the wireless communication device 102) to communicate with other devices, such as a cellular tower, a Wi-Fi router, a mobile device, plant probes, wireless nodes, access points, etc.

In some embodiments, the wireless communication device 102 can include electronic components 250, which can include amplifiers, a display (e.g., an LCD display, a touch screen display), inputs (e.g., a keypad, a touch screen, a keyboard, a mouse, etc.), outputs, etc. In some embodiments, the power source 242 can be a battery, an electrical cable, etc.

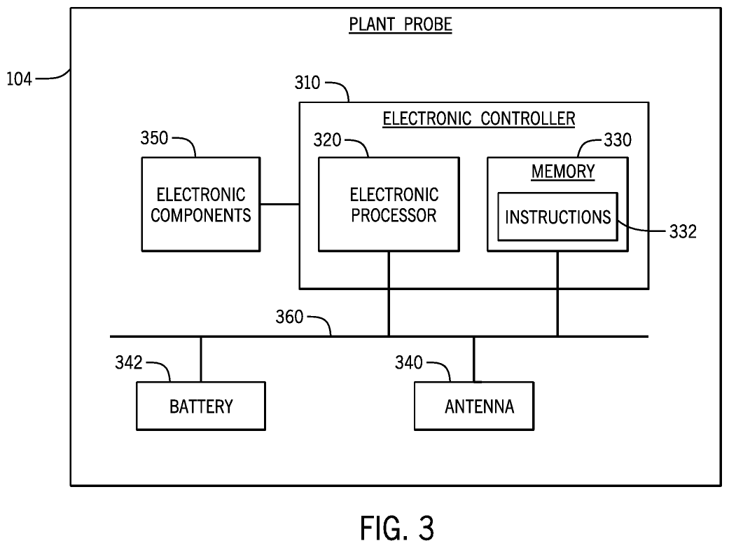

FIG. 3 is an electronics block diagram for a plant probe 104 according to one embodiment of the invention. In the example illustrated, the plant probe 104 can include an electronic controller 310, an antenna 340, electronic components 350, etc. In some embodiments, the electronic controller 310 can be similar to the electronic controller 210, and the antenna 340 can be similar to the antenna 240. For example, the electronic controller 310 can include an electronic processor 320 and memory 330. The electronic processor 320, the memory 330, and the antenna 340 can communicate over one or more control buses, data buses, etc., which can include a device communication bus 360. The electronic processor 320 can be configured to communicate with the memory 330 to store data and retrieve stored data. The electronic processor 320 can be configured to receive instructions and data from the memory 330 and execute the instructions. In particular, the electronic processor 320 executes instructions stored in the memory 330. Thus, the electronic controller 310 coupled with the electronic processor 320 and the memory 330 can be configured to perform the methods described herein (e.g., the processes 400 and 500 of FIGS. 4 and 5).

The memory 330 can include ROM, RAM, and/or other non-transitory computer-readable media. The memory 330 can include instructions 332 for the electronic processor 320 to execute. The instructions 332 can include software executable by the electronic processor 320 to enable the electronic controller 310 to determine and/or transmit data of the plant probe 104.

The antenna 340 can be communicatively coupled to the electronic controller 310. The antenna 340 enables the electronic controller 310 (and, thus, the plant probe 104) to communicate with other devices, such as the wireless communication device 102, wireless nodes 110, a cellular tower, a Wi-Fi router, a mobile device, other plant probes, access points, etc.

The plant probe 104 includes a battery 342. The battery 342 can be coupled to and configured to power the various components of the plant probe 104, such as the electronic controller 310, the antenna 340, and the electronic components 350. In some embodiments, the plant probe 104 also optionally includes additional electronic components 350. The electronic components 350 can include, for example, one or more of a lighting element (e.g., an LED), an audio element (e.g., a speaker), a power source, etc.

FIG. 4 illustrates a flowchart of a process 400 for automatically adjusting one or more settings of an automated plant maintenance system, which can be implemented using the plant probe system 100. The process 400 is generally described as being implemented by the wireless communication device 102 in the context of the plant probe system 100 in FIG. 1. However, in other embodiments, other plant probes or devices of the plant probe system 100, or other plant probes 104 or devices of other systems, may implement the process 400.

In block 402, the process 400 can include determining data of a plant (e.g., the plant 112). For example, the wireless communication device 102 can identify the type of plant and retrieve the plant data corresponding to that plant type from a memory (e.g., memory 230 of the wireless communication device, a memory of the server 108) or other database and/or data storage device or medium in communication with the wireless communication device 102.

The wireless communication device 102 can identify the type of plant in various different ways. For instance, camera 114 can record one or more images of the plant 112 and the wireless communication device 102 can receive and process the image (e.g., using the electronic processor 220 of the wireless communication device 102) to identify the type of plant. As an example, the electronic processor 220 of the wireless communication device 102 can implement a computer vision algorithm or other classifier algorithm to identify the type of plant from the image. The one or more images can be applied to the computer vision algorithm or other classifier algorithm, generating output as data that indicate the type of plant recorded by the camera.

For instance, a computer vision algorithm or other classifier algorithm can be implemented to determine features in the image that are associated with the plant 112, and which can be used to classify the type of plants. As an example, the features extracted from the image may include a size of the plant 112, a shape of the plant 112, or other features from the image such as edges, corners, interest points, blobs, region-of-interest points, and/or ridges. Other classifier algorithms can include machine learning algorithms, including support vector machine (“SVM”) and neural network (e.g., convolutional neural network) based machine learning algorithms.

In some embodiments, a type of plant or a type of seed can be determined by scanning or otherwise detecting a plant identifier on the plant 112 or seed packet. For instance, a barcode, quick response (“QR”) code, or other identifier on the plant 112 or seed packet can be scanned by a scanner (e.g., via the camera 114 or another scanning device of the wireless communication device 102 or a mobile phone camera). Alternatively, a user can use a mobile device to select a plant type identifier from a list of plant types stored in a database. The wireless communication device 102 can generate plant type data in response to detecting the plant identifier, such as by recording the plant identifier, querying a database of plant types stored in the memory 230, and retrieving and outputting the plant type data corresponding to the plant associated with the plant identifier. Additionally or alternatively, the server 108 can identify the type of plant using the methods described above (e.g., using an electronic processor and/or memory of the server 108).

In block 404, the process can include determining a type of plant 112. For example, the process can determine the type of plant 112 from the image data, from a barcode on the plant's pot/tag or seed packet, or from a QR code on the plant's pot/tag or seed packet.

In block 406, the process can include determining the location of the plant probe 104 and where a maintenance action should be performed. In some embodiments, the location data can be stored as relative positions (e.g., positions relative to a common reference point near the plant 112, such as an address or GPS location). The locations can be updated, as necessary, by updating the reference point of the plant 112, for example, if the plant probe 104 is moved from an outdoor garden to an indoor houseplant. The position of the plant 112 can, therefore, be known or otherwise determined relative to the wireless communication device 102 and/or wireless nodes 110 such that the locations contained in the location data can be determined within the frame of reference of the plant probe system 100. For example, the position of the plant 112 can be recorded using the camera 114 of the plant probe system 100. Alternatively, the plant probe 104 can be used to record the position of the plant 112. For example, the plant probe 104 can be moved to a position near the plant 112 and then the position of the plant probe 104 can be recorded as the reference location for the plant 112. In some embodiments, the position of the plant probe 104 can be determined by the plant probe system 100 (e.g., using the electronic processor 220 of the wireless communication device 102, the electronic processor 320 of the plant probe 104, or an electronic processor of the server 108 or one of the wireless nodes 110), generating output as plant probe position data. The plant probe position data can be communicated or otherwise transmitted to the wireless communication device 102, whether directly or indirectly via one or more wireless nodes 110. The position of the plant probe 104 can be determined within a frame of reference defined by or otherwise based on the locations of the wireless communication device 102 and/or wireless nodes 110.

The plant probe system 100 can use various tracking techniques to determine the position of the plant probe 104. For example, the location of the wireless communication device 102 and each wireless node 110 can be fixed and stored in the plant probe system 100 (e.g., in the memory 230 of the wireless communication device 102, the memory 330 of the plant probe 104, a memory of the server 108, a memory of each wireless node 110); or can be periodically determined and stored in the plant probe system 100. Further, the wireless communication device 102 and each wireless node 110 may communicate with the plant probe 104 and, based on a measurement of the communications, triangulate a location of the plant probe 104.

In block 408, the process can include determining one or more maintenance recommendations for the plant 112 based on the location of the plant probe 104. For example the plant probe system 100 can access information for the plant hardiness zones at the physical location of the plant probe 104 and the current weather for the location of the plant probe 104 to determine whether seeds should be planted, a plant should be watered, a plant should be covered before a frost, a plant should be fertilized, etc.

In block 410, the process can include transmitting the maintenance recommendation to a display of the plant probe or to a mobile device so that a user can implement the maintenance recommendation manually at the plant probe location. In addition or alternatively, the process can include transmitting the maintenance recommendation to an automated maintenance system, such as a watering system, a fertilizer application system, or artificial lights.

FIG. 5 illustrates a flowchart of a process 500 for automatically adjusting one or more settings of an automated maintenance system based on a location of the plant, which can be implemented using the plant probe system 100. In block 502, the plant probe 104 (e.g., the processor 320) transmits, via the antenna 340, one or more signals indicative of a position of the plant probe 104 to the wireless communication device 102. For example, the plant probe 104 may determine the location of the plant probe 104 (as described above with respect to block 406) and transmit the position (as part of the one or more signals) to the wireless communication device 102. As another example, the plant probe 104 may transmit one or more signals that are received by the wireless nodes 110 or other system 100 devices, from which the location of the plant probe 104 may be derived (e.g., as described above with respect to block 406).

In block 504, the manual or automatic maintenance system (e.g., the processor 320 for an automatic system) receives, via the antenna 340, a maintenance recommendation from the wireless communication device 102. The maintenance recommendation corresponds to a maintenance action to be performed at a location nearest to the plant probe position. For example, the wireless communication device 102 may transmit the maintenance recommendation to the plant probe 104 as described above with respect to block 410 of FIG. 4, where the maintenance recommendation is based on the position of the plant probe 104 and the location data for the plant 112.

In block 506, the maintenance system adjusts an operating parameter based on the maintenance recommendation from the wireless communication device 102. For example, if automated, the processor 340 may update a variable stored in a memory (e.g., register) of the processor 340 or the memory 330 that indicates the operating parameter. In this manner, an operating parameter can be provided to a watering system, a fertilizer application system, or artificial lights.

In block 508, an actuator of the maintenance system operates in accordance with the operating parameter. For example, the processor 340 may detect actuation of an input device and then drive a switch, valve, or motor or other actuator of the maintenance system according to the operating parameter. In this manner, the watering system can be turned on at a particular flow rate and temperature, a particular fertilizer can be dispensed in a particular amount, and artificial lights can be turned on or off or their light frequencies or intensities can be set or changed.

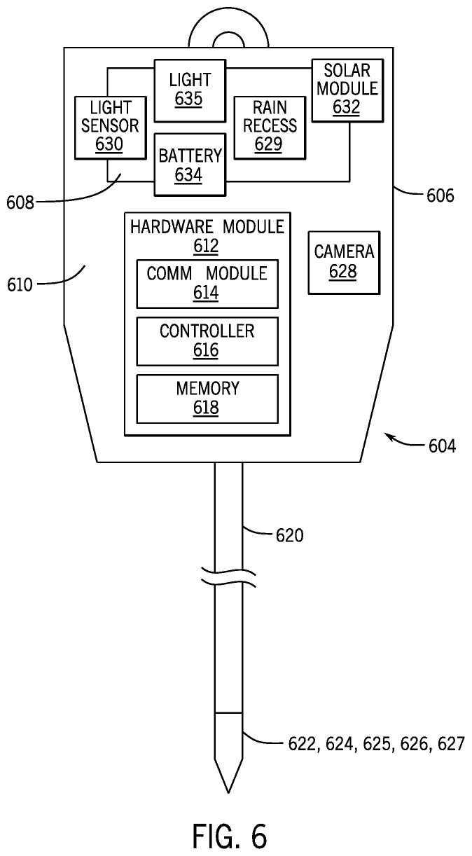

FIG. 6 illustrates a plant probe 604 according to one embodiment of the invention. The plant probe 604 can include a body 606 and, in some embodiments, a display 608. The body 604 can be substantially water and weather proof. The display 608 can be a LCD display, a light indicator, and/or an audio indicator. The plant probe 604 includes a housing 610 including a hardware module 612 connected to the display 608. The hardware module 612 includes a communication module 614, an electronic controller 616, and memory 618. The plant probe 604 includes a probe 620 including a sensor module 622. The sensor module 622 can include a moisture sensor 624 and/or a growing media sensor 626. In some embodiments, the growing media sensor 626 can differentiate between fluids, hydroponic growing media, clay, sand, potting soil, top soil, compost, organic matter, and other types of growing media, soil, and soil amendments. For example, the growing media sensor 626 can provide data regarding percentages of each type of growing media sensed by the plant probe 604. The moisture sensor 624 can also include a humidity sensor 625. In some embodiments, at least one of the body 606 or the probe 620 includes a temperature sensor 627.

In some embodiments, the plant probe 604 can include a rain recess 629 to accumulate rain water on a daily or weekly basis. The rain recess 629 can accumulate water that is sensed by a conductivity or ultrasonic sensor and then automatically drains after a reading is stored in the memory 618. The conductivity can be measured by applying an alternating electrical current to sensor electrodes at least partially immersed in the rain water and measuring the resulting voltage. The rain water acts as the electrical conductor between the sensor electrodes. Alternatively or in addition, an ultrasonic sensors can be mounted over the rain water. To determine the distance to the rain water, the ultrasonic sensor transmits a sound pulse that reflects from the surface of the rain water and measures the time it takes for the echo to return. In one or both of these manners, the rain recess 629 can measure the number of inches of rain water accumulated over a daily or weekly basis. Once the number of inches of rain water is known, the controller 616 can send a signal recommending a watering action.

The moisture sensor 624 can place a small charge on electrodes and electrical resistance through the sensor can be measured. As water is used by plants or as the soil moisture decreases, water is drawn from the sensor and resistance increases. Conversely, as soil moisture increases, resistance decreases. The humidity sensor 625 can be a capacitive humidity sensor that measures relative humidity by placing a thin strip of metal oxide between two electrodes, so that the metal oxide's electrical capacity changes with the atmosphere's relative humidity. The growing media sensor 626 can sense at least one of pH, nitrogen, phosphorous, or potassium. The growing media sensor 626 can measure hydrogen-ion activity (acidity or alkalinity). The growing media sensor 626 can include a voltmeter attached to a pH-responsive electrode and a reference electrode. The growing media sensor 626 can measure fertilizer using a fertometer, which is an electrical conductivity meter that measures the total salt concentration in the soil. The temperature sensor 627 can include diode terminals across which the voltage is measured. If the voltage increases, the temperature also rises, followed by a voltage drop between the transistor terminals of base and emitter in a diode. The light sensor 630 can include a light meter that measures incidental, ambient light, and/or reflective light through a photo cell that reacts to the intensity of the light (e.g., a photometer). Each of the sensors in the sensor module 622 can be integrated structurally and electrically in order to provide the smallest sensor module possible to fit within the probe 620.

In some embodiments, one of the body 606 and the housing 610 includes a camera 628. Alternatively, the camera of a mobile device or personal computer can be used with the control system 700 to capture images of the plant 112. In some embodiments, the body 606 includes the light sensor 630 that senses at least one of light intensity or light duration. In some embodiments, the body 606 includes a solar module 632 and the housing includes a battery 634 charged by the solar module 632. When exposed to sunlight, the photovoltaic cells in the solar module 632 receive energy which they absorb. The photovoltaic cells transfer the absorbed energy to a semiconductor which creates an electric field, which in turn delivers voltage and current to be stored in the battery 634. The battery 634 can be connected to the electronic controller 616. The battery 634 can also be a convention electrochemical cell battery or rechargeable battery pack. In some embodiments, the plant probe 604 can include an indicator light 635 in order to provide notifications and in order to serve as a locator to help a user find the plant probe 104 within the vegetation of the garden.

In some embodiments, the communication module operates according to the Bluetooth protocol to communicate with a mobile device, such as a mobile phone, tablet, or personal computer. In some embodiments, the housing 610 includes an accelerometer and/or a gyroscope in order to sense movement or orientation of the plant probe 104.

In some embodiments, the body 606 and housing 610 can be integrated into a single unit and the probe 620 can be coupled to the body 606 and/or housing 610 with a cable. In other embodiments, the body 606, the housing 610, and the probe 620 can each be physically coupled to one another to form a single integral or monolithic unit, and in some embodiments, including the rain recess 629 and its valve formed within a portion of the body 606.

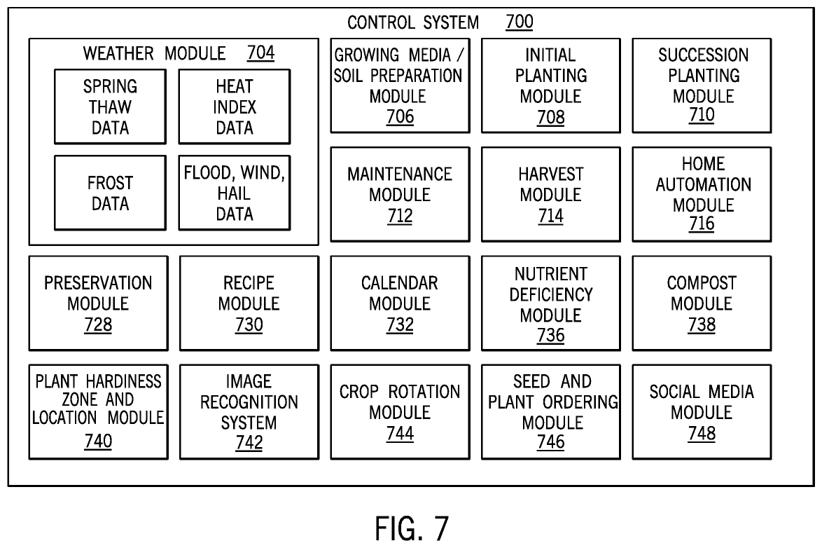

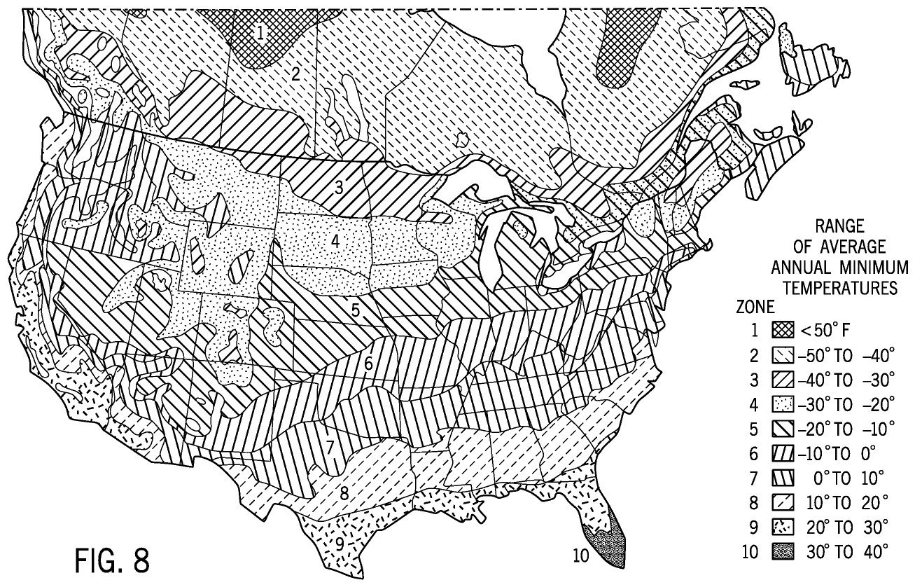

FIG. 7 illustrates a control system 700 according to some embodiments of the invention. The plant probe system 100 of FIG. 1 can include the control system 700, which can be implemented by the wireless communication system 102 of FIG. 1 and/or a software application on a mobile device. The control system 700 communicates with the communication module 614 of the plant probe 604. The control system 700 receives data from the sensor module 622 and uses the data to provide recommendations, for example, by displaying maintenance recommendations on the display 608 of the plant probe 604 or by sending a notification to a mobile device. The control system 700 can include a search function in order to find information regarding particular plants or any of the particular modules shown in FIG. 7.

The control system 700 can implement machine learning methods of data analysis that automate analytical model building. The control system 700 learns from data received from the plant probe and the various control system modules described below to identify patterns and make decisions with minimal user intervention. In some embodiments, the control system 700 can use blockchain by structuring data into chunks that are chained together. For example, the control system 700 can create a timeline of chronological plant data, weather data, maintenance action data, etc. with each block being given an exact timestamp when it is added to the chain.

The control system 700 can include any one or more of the following modules: a weather module 704, a growing media/soil preparation module 706, an initial planting module 708, a succession planting module 710, a maintenance module 712, a harvest module 714, a home automation module 716, a preservation module 728, a recipe module 730, a calendar module 732, a nutrient deficiency module 736, a compost module 738, a plant hardiness zone and location module 740, an image recognition system 742, a crop rotation module 744, a seed and plant ordering module 746, and/or a social media module 748.

The control system 700 can include the weather module 704 to provide recommendations for planting dates and maintenance actions. The weather module 704 can serve a number of functions, including predicting the following: when the soil will be warm enough for spring planting; when the soil will be warm enough for tender plants and herbs; when the summer heat index will cause certain plants to bolt, wilt, or die; when the first fall frost will arrive; when heavy rains, floods, winds, and hail may damage plants, etc. The weather module 704 can communicate with the sensor module 622, the camera 628, and the light sensor 630 in order to determine the current conditions near the plant 112. In addition, the weather module 704 can access historical weather pattern data for a particular location and use algorithms, machine learning, or artificial intelligence to predict when various conditions will occur affecting the health of the plant 112. As weather patterns change, the weather module 704 can use adaptive algorithms to change baseline parameters for local temperature, moisture, humidity, etc. In addition, the weather module 704 can use algorithms that consider the light intensity at a particular location, along with the light duration for a given day in a given season. For example, even though the temperature may remain high in the fall, the light duration starts to decrease affecting the ability of vegetables to ripen.

The control system 700 can include the growing media or soil preparation module 706 to analyze data from the growing media sensor 626 to determine pH, nitrogen, phosphorous, and/or potassium and provide recommendations for fertilizer application. Also, the growing media or soil preparation module 706 can provide instructions for spring or fall soil preparation, such as tilling the soil after adding top soil, compost, manure, and/or organic matter. The growing media or soil preparation module 706 can also provide recommendations for mulching around plants, using organic materials, such as straw, woodchips, shredded leaves, etc.

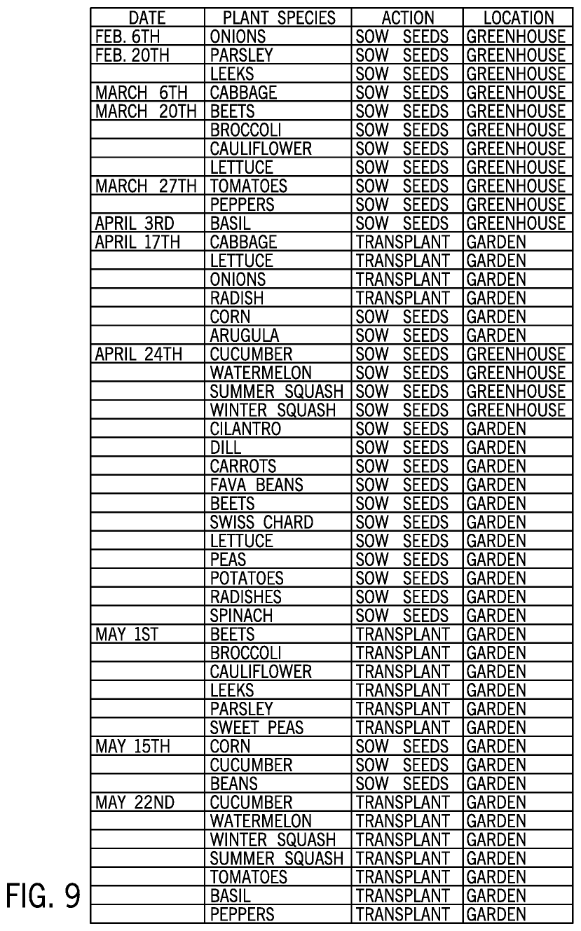

The control system 700 can include the initial planting module 708 to provide recommendations regarding at least one of planting locations, plant species, or companion planting. In some embodiments, the initial planting module 708 can communicate with the calendar module 732 to generate calendar appointments according to a schedule, such as the planting schedule shown in FIG. 9. In some embodiments, the initial planting module 708 can generate calendar appointments for planting spring bulbs in the fall and for planting bulbs to bloom before certain holidays. The initial planting module 708 can recommend companion plants, such as certain ornamental flowers that attract bees to a vegetable patch (e.g., borage, dahlia, sunflowers, marigold, salvia, verbena, bee balm, snapdragons, zinnia, ageratum, etc.). The initial planting module 708 can also recommend interplanting certain species to add nitrogen to the soil for heavy nitrogen feeders, such as broccoli and cauliflower. The initial planting module 708 can recommend interplanting certain plant species that detract pests, such as dill and chamomile planted near broccoli and cauliflower. The initial planting module 708 can provide instructions for seed depth, seed spacing, transplant spacing, and soil amendments for each particular plant species. The initial planting module 708 can provide recommendations for stakes, supports, trellises, frost blankets, and cold frames for particular plants species, such as species that should be supported, including peas, beans, tomatoes, squash, cucumbers, etc. In addition, the initial planting module 708 can recommend that particular vegetable species be planted together (e.g., corn with potatoes) or apart (e.g., not planting corn with tomatoes).

The control system 700 can include the succession planting module 710 to provide recommendations regarding succession planting for multiple crops being periodically harvested during a growing season. For example, the succession planting module 710 can determine when to plant additional vegetables according to a harvest schedule. The succession planting module 710 can communicate with the weather module 704 and the growing media/soil preparation module 706 to help determine the timing and conditions for subsequent crops and crop rotation. For example, the succession planting module 710 can provide a notification to the user to plant additional seeds for leafy greens one week apart after the initial planting date and according to the conditions communicated by the various sensors 622, the weather module 704, and the growing media/soil preparation module 706. The succession planting module 710 can also provide species suggestions for transitioning from early planting species for cool spring weather before or after the spring thaw, to species that withstand or thrive in summer heat, to species that can handle some frost and winter cold. The succession planning module 710 can recommend species that will not bolt as quickly under certain weather conditions, such as summer heat. The succession planting module 710 can recommend a final date for fall planting for a particular species to be harvested before the first fall frost or to be harvested in early winter. The succession planting module 710 can recommend species that are particularly well suited for storage through the winter, such as particular carrot, potato, and beet species. The succession planting module 710 can recommend crops for cool season planting and crops for warm season planting.

The control system 700 can include the maintenance module 712 to provide recommendations regarding watering, fertilizer, pest control, sunlight, and/or artificial light. The maintenance module 712 can access plant information to determine the watering, fertilizing, and light needs for each particular species. Using data from the growing media sensor 626, the rain recess 629, and the light sensor 630, the maintenance module 712 can determine whether the particular species needs additional fertilizer, water, and/or light. The maintenance module 712 can also include algorithms to maintain house plants or greenhouse plants. For example, the maintenance module 712 can communicate with a thermostat, a humidifier, and/or a dehumidifier in order to determine ideal growing conditions and communicate with the home automation module 716 to send commands to control the thermostat, humidifier, or dehumidifier to achieve the ideal growing conditions in an enclosed space, such as a residential home, business, or greenhouse.

The control system 700 can include the harvest module 714 to provide recommendations regarding dates for harvesting plants during a growing season. Based on the particular species, the harvest module 714 can provide date ranges for harvesting. The harvest module 714 can communicate with the calendar module 732 to generate calendar appointments when each particular species should be harvested.

The control system 700 can include the home automation module 716 that provides control signals for sprinklers, drip hoses, drip lines, valves, pumps, artificial lights, and/or heaters. Based on the rain recess 629 data and the temperature data from the plant probe 604, the home automation module 716 can control valves and pumps to deliver additional water to the garden or a particular species. Based on the light sensor 630, the home automation module 716 can turn on or off additional artificial light sources or change their light wavelengths or intensities (e.g., for artificial lights including an array of light emitting diodes). Based on the data from the camera 628, the home automation module 716 can determine that the garden is flooding or that the watering system is leaking and send a notification to the home owner. The control system 700 can include the preservation module 728 to provide recommendations regarding drying, freezing, storing, and/or canning harvested plants. For example, planting too many plants can results in a very large harvest within a few days or weeks, such as too many tomatoes or tomatillos. The preservation module 728 can provide recommendations for preserving the harvest of a particular species according to the number of plants that have been planted and their condition (e.g., based on data from the camera 628).

The control system 700 can include the recipe module 730 to provide recommendations for recipes using a harvested plant. Similar to the preservation module 728, the recipe module 730 can provide recommendations for using the harvest of a particular species according to the number of plants that have been planted and their condition. The recipe module 730 can also communicate with the calendar module 732 to provide calendar appointments for labor intensive recipes requiring additional time over a weekend, for example.

The control system 700 can include the calendar module 732 to populate an electronic calendar with recommended dates for planting, maintaining, and/or harvesting plants within a growing season. The calendar module 732 can communicate with the weather module 704 in order to automatically generate and populate calendar appointments on dates when the conditions will be suitable for a particular plant species. For example, the calendar module 732 can generate calendar appointments for the various dates shown in FIG. 9 to sow seeds in the greenhouse, sow seeds directly in the garden, transplant seedlings from the greenhouse to the garden, or transplant plants purchased at a gardening center or online resource. The calendar module 732 can also group tasks according to when the gardener has availability to complete the tasks, such as a particular weekend day when the local weather, according to the weather module 704, will be suitable for gardening tasks.

The control system 700 can include the nutrient deficiency module 736 to provide an alert or recommend a maintenance action when data from the growing media sensor 626 indicates a nutrient deficiency. For example, the nutrient deficiency module 736 can provide recommendations regarding whether to amend the growing media or soil with nitrogen for green growth, phosphorus for flower, fruit, and root growth, or potassium for stem strength. In addition, the nutrient deficiency module 736 can communicate with the compost module 738 to recommend compost or soil amendments, including particular fertilizers with particular ratios of nitrogen, phosphorus, and potassium.

The control system 700 can include the compost module 738 to provide recommendations for growing media amendments based on data received from the growing media sensor 626. The compost module 738 can provide instructions for generating a compost pile or bin, including the ingredients (e.g., fruit and vegetable scraps, eggshells, coffee grounds, grass clippings, leaves, newspaper, etc.) and the brown matter and green matter ratios for producing compost. The compost module 738 can determine the quantity of compost necessary for the garden and communicate with the seed and plant ordering module 746 to order a sufficient quantity of compost (e.g., three bags of compost with one cubic foot per bag for a bed measuring four feet by eight feet).

The control system 700 can include the plant hardiness zone and location module 740 to determine the historic and future planting conditions at the location of the plant probe 604. The plant hardiness zone and location module 740 can communicate with the moisture sensor 624, the humidity sensor 625, the growing media sensor 626, the temperature sensor 627, the rain recess 629, and the light sensor 630. The control system 700 can recommend particular species to plant based on historical plant hardiness zones for a particular garden location, but also based on the various sensors 622 that provide actual data that is contrary to a particular plant hardiness zone for a particular location. For example, the average first frost date may be October 15th, but the sensors 622 may be providing data indicating that the first frost has not yet occurred. In addition, the weather module 704 may provide forecasts that are used to indicate that the first frost will not occur for a number of additional days or weeks. The plant hardiness zone and location module 740 can also communicate (a) with the initial planting module 708 to determine when the spring thaw date or last frost will occur, (b) with the succession planting module 710 to determine when a subsequent crop can be planted so that an additional harvest can be gathered before the first frost in the fall, and (c) with the maintenance module 712 or the home automation module 716 to provide crop covers or artificial light to extend the growing season beyond the normal weather patterns for a particular hardiness zone.

The control system 700 can include the image recognition system 742 that receives image data from the camera 628 or a mobile phone to determine plant type, plant condition, pest presence, or weed presence. The image recognition system 742 uses visual search technology to identify objects through the plant probe camera 628 or the mobile device's camera. The visual search uses artificial intelligence technology to search through the use of plant imagery, rather than through text search.

The control system 700 can include the crop rotation module 744 that can determine the nutrient removed from the soil from one crop and recommend a new crop for the following planting or growing season. Some crops are heavy feeders; heavy feeders include tomatoes, broccoli, cabbage, corn, eggplant, beets, lettuce, and other leafy crops. Some crops are light feeders; light feeders include garlic, onions, peppers, potatoes, radishes, rutabagas, sweet potatoes, Swiss chard, and turnips. Some crops are soil builders; soil builders include peas, beans, and cover crops such as clover. Rotating these three groups of crops makes the best use of nutrients in the soil. Simple crop rotation would plant heavy feeders in a dedicated planting bed the first year, followed by light feeders in the same bed the second year, followed by soil builders the third year. This rotation presumes there are separate planting areas big enough for all of the crops in each of the three rotation groups.

The crop rotation module 744 uses the following major vegetable plant families and suggestions for crop rotation recommendations. Onion Family, Amaryllidaceae: Garlic, onions, leeks, shallots. These are light feeders. Plant onion family crops after heavy feeders. Follow onion family crops with legumes. Cabbage Family, Brassicaceae (Cruciferae): Broccoli, Brussels sprouts, cabbage, cauliflower, Chinese cabbage, collards, cress, kale, kohlrabi, radishes, turnips. These are heavy feeders. Plant cabbage family crops after legumes. After cabbage family crops build the soil for a season with a cover crop or soil building compost or let the area sit fallow for a season after applying well-aged manure. Lettuce Family, Asteraceae (Compositae): Artichokes, chicory, endive, lettuce. These are heavy feeders. Follow lettuce family crops with soil building legumes. Grains, Grass Family, Poaceae (Gramineae): Grains—oats, corn, rye, wheat. Follow these crops with tomato family plants. Legume Family, Fabaceae (Leguminosae): Beans, peas, clover, vetch. These are soil enrichers. Follow legume family plants with any other crop. Tomato Family, Nightshade Family, Solanaceae: Eggplant, peppers, tomatoes, potatoes. Nightshade family crops are heavy feeders. Plant these crops after grass family plants. Follow heavy feeders with legume family crops to re-build the soil. Squash Family, Cucurbitaceae: Cucumbers, melons, summer and winter squash, pumpkins, watermelon. Squash family plants are heavy feeders. Plant these crops after grass family plants. Follow heavy feeders with legume family crops to re-build the soil. Carrot Family, Apiaceae (Umbelliferae): Carrots, celery, anise, coriander, dill, fennel, parsley. Beets and chard, Amaranthaceae, can be grouped with the carrot family crops. These are light to medium feeders. Carrot family crops can follow any other crop. Follow carrot family crops with legumes or onion family crops.

In one embodiment, to follow a simple four-year crop rotation, the crop rotation module 744 recommends dividing the garden into four areas or plots: Plot One, Plot Two, Plot Three, and Plot Four. In each of the next four years, the control system 700 recommends growing a different crop or different members of the four crop families in a different plot following the following rotation: Plot One: Tomato family (year 1); Others (year 2); Bean family (year 3—but avoid planting beans where onion family crops have just grown); Cabbage family (year 4). Plot Two: Cabbage family (year 1); Tomato family (year 2); Others (year 3); Bean family (year 4—but avoid planting beans where onion family crops have just grown). Plot Three: Bean family (year 1—but avoid planting beans where onion family crops have just grown); Cabbage family (year 2); Tomato family (year 3); Others (year 4). Plot Four: Others (year 1); Bean family (year 2—but avoid planting beans where onion family crops have just grown); Cabbage family (year 3); Tomato family (year 4). The “Others” can include sweet corn squashes, zucchini, and pumpkins (marrow and courgettes), and lettuces. The crop rotation module 744 can following additional rules including: avoid planting beans in the same location after garlic; avoid planting beans in the same location after leeks; avoid planting beans in the same location after onions; and avoid planting beans in the same location after shallots. The crop rotation module 744 can account for perennial vegetables that are not included in crop rotation, because perennial vegetable crops can grow in the same spot for several years in a row. Perennial crops include asparagus, globe artichokes, Jerusalem artichokes, perennial herbs, rhubarb, and seakale.

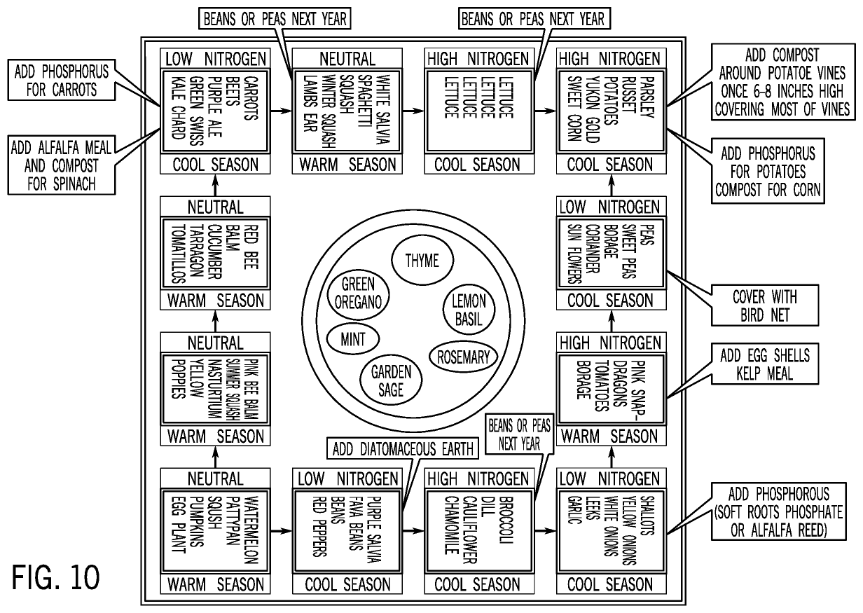

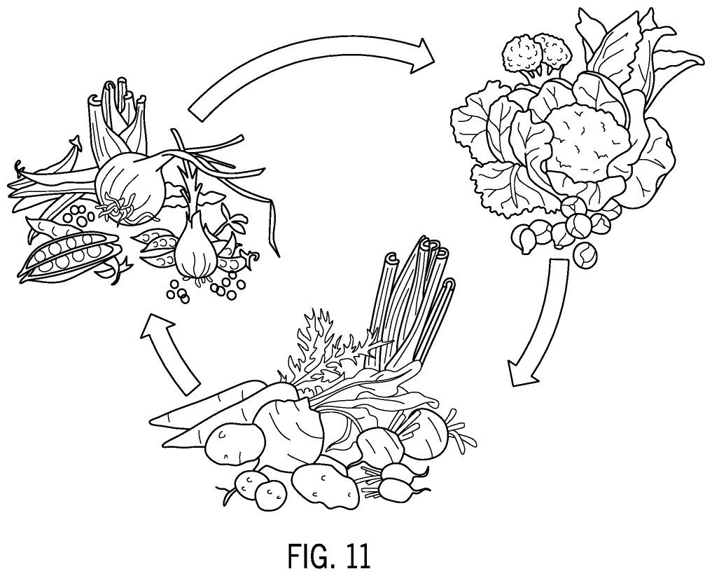

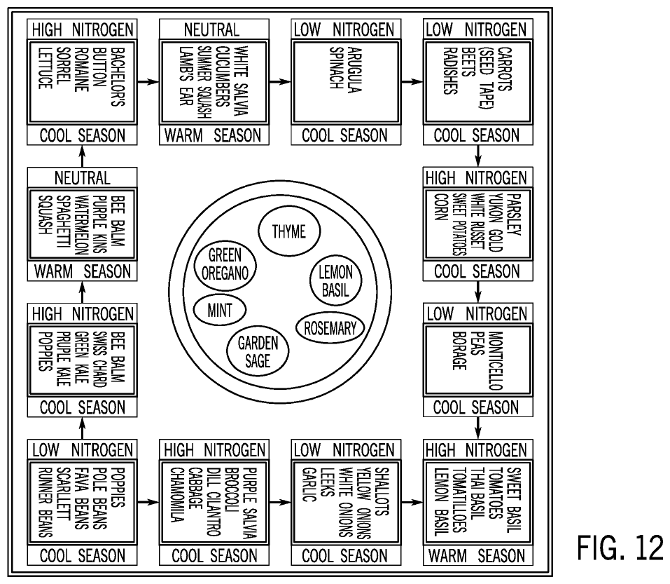

The crop rotation module 744 can expand beyond four plots. As shown in FIG. 10, the control system 700 and the initial planting module 708 can generate a garden plant for twelve plots or raised beds. In some embodiments, the initial planting module 708 can also generate companion plant recommendations, as shown in FIG. 10. Crops in the plots or raised beds can be rotated according to FIG. 11 to achieve the crop rotation shown in FIG. 12. The nutrient deficiency module 736 can determine the nutrient requirements for each crop (e.g., low nitrogen, neutral, or high nitrogen). The nutrient deficiency module 736 can recommend particular growing media amendments, such as the various organic soil amendments shown in FIG. 10 (e.g., alfalfa meal, compost, liquid seaweed, kelp meal, rock phosphate, wood ash, cotton seed hulls, iron sulfate, aluminum sulfate, Sulphur, etc.). The crop rotation module 744 can also recommend particular cover crops for the end of the growing season, such as white clover, crimson, winter rye, oats, field peas, and alfalfa.

The control system 700 can include a seed and plant ordering module 746 to recommend when and where to buy particular seed varieties or plants for transplanting. In some embodiments, the seed and plant ordering module 746 can automatically order additional seeds or plant transplants from an online shopping system.

The control system 700 can include a social media module 748 to connect with social media platforms to share pictures, information, and engage in online group discussions. In some embodiments, the control system 700 can include a search function to search for data related to any of the various modules, to search the Internet, or to search social media posts.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some embodiments, computerized implementations of methods according to the disclosure can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (“CD”), digital versatile disk (“DVD”), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (“LAN”). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

Various features and advantages of the disclosure are set forth in the following claims.

1. A method of providing a maintenance action for a plant based on a location of a plant probe, the method comprising:
positioning a plant probe;
determining a location of the plant probe;
determining, by an electronic controller, a maintenance action to be performed at the location of the plant probe; and
transmitting, by the electronic controller, the maintenance action to at least one of a display on the plant probe, a display on a mobile device, or an actuator of an automated maintenance system.

2. The method of claim 1 and further comprising determining plant data that indicates a plant type.

3. The method of claim 2 wherein determining the plant data comprises recording an image of the plant and processing the image to determine the plant type.

4. The method of claim 3 wherein processing the image to determine the plant type comprises applying the image to a computer vision algorithm using the electronic controller, and generating output as the plant data.

5. The method of claim 2 wherein determining the plant data comprises scanning an identifier on the plant and generating an output indicative of the identifier as the plant data.

6. The method of claim 5 wherein the identifier is a barcode.

7. The method of claim 5 wherein the identifier is a quick response (QR) code.

8. The method of claim 2 wherein determining the plant data includes receiving, by the electronic controller, a user selection of the plant type from a list of plant types stored in a database.

9. The method of claim 1 wherein transmitting the maintenance action includes transmitting at least one of a watering action, a fertilizing action, a weeding action, and a light exposure action.

10. The method of claim 9 wherein transmitting the maintenance action includes transmitting an action to the display to be manually performed by a user.

11. The method of claim 9 wherein transmitting the maintenance action includes transmitting a watering action to an automated watering system.

12. The method of claim 11 wherein transmitting the watering action includes transmitting a control signal for at least one of a valve or a pump.

13. The method of claim 9 wherein the transmitting the maintenance action includes transmitting a signal to operate an artificial light.

14. The method of claim 1 wherein positioning the plant probe includes positioning a probe in at least one of soil or fluid.

15. The method of claim 1 wherein determining the position of the plant probe includes using a global positioning system.

16. The method of claim 1 and further comprising determining the presence of at least one a pest or insect.

17. The method of claim 16 wherein the maintenance action includes a pest remediation action.

18. The method of claim 1 and further comprising determining the presence of a weed.

19. The method of claim 1 and further comprising determining a location of the plant probe includes determining that the plant probe is located indoors or outdoors.

20. A plant probe comprising:
a body including a display;
a housing including a hardware module connected to the display, the hardware module including a communication module, an electronic controller, and memory; and
a probe including a sensor module, the sensor module including at least one of a moisture sensor or a growing media sensor.

21. The plant probe of claim 20 wherein one of the body and the housing includes a camera.

22. The plant probe of claim 20 wherein the body includes a light sensor.

23. The plant probe of claim 22 wherein the light sensor senses at least one of light intensity or light duration.

24. The plant probe of claim 20 wherein the growing media sensor senses at least one of pH, nitrogen, phosphorous, or potassium.

25. The plant probe of claim 20 wherein the body includes a solar module and the housing includes a battery charged by the solar module, the battery connected to the electronic controller.

26. The plant probe of claim 20 wherein the communication module operates according to Bluetooth protocol to communicate with a mobile device.

27. The plant probe of claim 20 wherein the housing includes an accelerometer.

28. The plant probe of claim 20 wherein the housing includes a gyroscope.

29. The plant probe of claim 20 wherein the body is directly coupled to the housing and the probe is indirectly coupled to at least one of the body or the housing.

30. The plant probe of claim 20 wherein the probe is directly coupled to at least one of the body or the housing.

31. A plant probe system comprising:
a plant probe including
a body with a display;
a housing with a hardware module connected to the display, the hardware module including a communication module, an electronic controller, and memory; and
a probe including a sensor module, the sensor module including at least one of a moisture sensor or a growing media sensor;
a control system in communication with the communication module, the control system receiving plant data from the sensor module, the control system using the plant data to provide plant recommendations.

32. The plant probe system of claim 31 wherein at least one of the body or the probe includes a temperature sensor.

33. The plant probe system of claim 31 wherein the control system includes a weather module to provide recommendations for planting dates.

34. The plant probe system of claim 31 wherein the control system includes a growing media module to analyze data from the growing media sensor to determine at least one of pH, nitrogen, phosphorous, or potassium and provide recommendations for fertilizer application.

35. The plant probe system of claim 31 wherein the control system includes a planting module to provide recommendations regarding at least one of planting locations, plant species, or companion plantings.

36. The plant probe system of claim 31 wherein the control system includes a succession planting module to provide recommendations regarding succession planting for crops being periodically harvested during a growing season.

37. The plant probe system of claim 31 wherein the control system includes a maintenance module to provide recommendations regarding at least one of watering, fertilizer, pest control, sunlight, or artificial light.

38. The plant probe system of claim 31 wherein the control system includes a harvest module to provide recommendations regarding dates for harvesting plants during a growing season.

39. The plant probe system of claim 31 wherein the control system includes a home automation module that provides control signals for at least one of a sprinkler, a drip hose, a drip line, a valve, a pump, or an artificial light.

40. The plant probe system of claim 31 wherein the control system includes a preservation module to provide recommendations regarding at least one of drying, freezing, storing, or canning harvested plants.

41. The plant probe system of claim 31 wherein the control system includes a recipe module to provide recommendations for recipes using a harvested plant.

42. The plant probe system of claim 31 wherein the control system includes a calendar module to populate a calendar with recommended dates for at least one of planting, maintaining, or harvesting plants within a growing season.

43. The plant probe system of claim 31 wherein the control system includes a nutrient deficiency module to provide an alert when data from the growing media sensor indicates a nutrient deficiency.

44. The plant probe system of claim 31 wherein the control system includes a compost module to provide recommendations for growing media amendments based on data received from the growing media sensor.

45. The plant probe system of claim 31 wherein the control system includes a location module to determine a location of the plant probe.

46. The plant probe system of claim 31 wherein at least one of the body or the housing includes a camera, and the control system includes an image recognition system that receives image data from the camera, the image recognition system determining at least one of plant type, pest presence, or weed presence.

47. The plant probe system of claim 31 wherein the control system includes a crop rotation module to determine nutrients stripped from growing media from a first crop and recommend a second crop for a subsequent planting.

48. A method of providing a planting action, the method comprising:
positioning a plant probe;
determining a location of the plant probe;
determining a plant type;
determining a plant hardiness zone at the location;
determining a succession planting date for the plant type at the location in the plant hardiness zone;
generating an automatic calendar entry for the succession planting date; and
transmitting the automatic calendar entry to a mobile device.

49. The method of claim 48 and further comprising determining a succession planting date for the plant type in the plant hardiness zone in order to harvest produce before a first frost date.

50. The method of claim 48 and further comprising determining a harvest date and generating an automatic calendar entry for the harvest date.

51. The method of claim 48 and further comprising accessing current weather data and generating the automatic calendar entry date based on the current weather data.

52. The method of claim 48 and further comprising recommending a plant species suitable for harvest before a first frost date.

53. The method of claim 48 and further comprising recommending a plant species suitable for a particular growing season.

54. A method of providing a planting action, the method comprising:
positioning a plant probe;
determining a location of the plant probe;
determining a first plant type;
determining a nutrient requirement for the first plant type in a growing media; and
recommending a second plant type to replenish the nutrient requirement in the growing media.

55. The method of claim 54 and further comprising recommending a cover crop to replenish the nutrient requirement.

56. The method of claim 54 and further comprising recommending a legume to replenish depleted nitrogen.

57. The method of claim 54 and further comprising recommending a crop rotation plan for a plurality of garden beds.

58. A method of providing a maintenance action for a plant, the method comprising:
positioning a plant probe in growing media, the plant probe including a growing media sensor;
determining, by an electronic controller, a fertilizer need based on data from the growing media sensor;
determining, by the electronic controller, a fertilizing action to be performed based on the fertilizer need; and
transmitting, by the electronic controller, the fertilizing action to at least one of a display on the plant probe, a display on a mobile device, or an actuator of an automated fertilizer system.

59. The method of claim 58 and further comprising selecting by a user a fertilizer type including organic or inorganic.

60. The method of claim 58 and further comprising automatically providing, by the electronic controller, a fertilizer recommendation including a ratio of nitrogen, phosphorus, and potassium.

61. The method of claim 58 and further comprising automatically providing, by the electronic controller, a fertilizer recommendation including at least one of compost, manure, or organic matter.

62. The method of claim 58 and further comprising determining plant data that indicates a plant type.

63. The method of claim 62 wherein determining the plant data comprises recording an image of the plant and processing the image to determine the plant type.

64. The method of claim 63 wherein processing the image to determine the plant type comprises applying the image to a computer vision algorithm using the electronic controller, and generating output as the plant data.

65. The method of claim 62 wherein determining the plant data comprises scanning an identifier on the plant and generating an output indicative of the identifier as the plant data.

66. The method of claim 65 wherein the identifier is a barcode.

67. The method of claim 65 wherein the identifier is a quick response (QR) code.

68. The method of claim 62 wherein determining the plant data includes receiving, by the electronic controller, a user selection of the plant type from a list of plant types stored in a database.

69. The method of claim 58 and further comprising transmitting a maintenance action including transmitting at least one of a watering action, a weeding action, and a light exposure action.

70. The method of claim 69 wherein transmitting the maintenance action includes transmitting an action to the display to be manually performed by a user.

71. The method of claim 69 wherein transmitting the maintenance action includes transmitting a watering action to an automated watering system.

72. The method of claim 71 wherein transmitting the watering action includes transmitting a control signal for at least one of a valve or a pump.

73. The method of claim 69 wherein the transmitting the maintenance action includes transmitting a signal to operate an artificial light.

74. The method of claim 58 wherein positioning the plant probe includes positioning a probe in at least one of soil and fluid.

75. The method of claim 58 and further comprising determining the position of the plant probe using a global positioning system.

76. The method of claim 58 and further comprising determining the presence of at least one a pest or insect.

77. The method of claim 76 and further comprising determining and transmitting a pest remediation action.

78. The method of claim 58 and further comprising determining the presence of a weed.

79. The method of claim 58 and further comprising determining a location of the plant probe includes determining that the plant probe is located indoors or outdoors.

80. A plant probe comprising:
a body including a rain recess and a valve, the rain recess accumulating rain water when the valve is closed;
a housing including a hardware module, the hardware module including a communication module, an electronic controller, and memory; and
a probe including a sensor module, the sensor module including a moisture sensor;
the electronic controller determining a rain water volume based on a water level in the rain recess, the electronic controller storing the rain water volume in the memory, the electronic controller determining a watering need based on the rain water volume and data from the moisture sensor, the communication module transmitting the watering need to a remote device, the electronic controller automatically opening the valve to release rain water from the rain recess after a predetermined time period.

81. The plant probe of claim 80 wherein the predetermined time period is one day, the electronic controller automatically opens the valve once per day, and the rain water volume is transmitted as a weekly rain water volume.

82. The plant probe of claim 80 wherein the body includes a light sensor.

83. The plant probe of claim 82 wherein the light sensor senses at least one of light intensity or light duration.

84. The plant probe of claim 80 and further comprising a growing media sensor that senses at least one of pH, nitrogen, phosphorous, or potassium.

85. The plant probe of claim 80 wherein the body includes a solar module and the housing includes a battery charged by the solar module, the battery connected to the electronic controller.

86. The plant probe of claim 80 wherein the communication module operates according to Bluetooth protocol to communicate with a mobile device.

87. The plant probe of claim 80 wherein the housing includes an accelerometer.

88. The plant probe of claim 80 wherein the housing includes a gyroscope.

89. The plant probe of claim 80 wherein the body is directly coupled to the housing and the probe is indirectly coupled to at least one of the body or the housing.

90. The plant probe of claim 80 wherein the probe is directly coupled to at least one of the body or the housing.
